(19) United States
(12) Patent Application Publication
(10) Pub. No.: US 2026/0359929 A1
(43) Pub. Date: Nov. 12, 2026

(54) DISPLAY INTERACTION METHOD, DEVICE AND STORAGE MEDIUM

(71) Applicant: Beijing Volcano Engine Technology Co., Ltd., Beijing (CN)

(72) Inventors: Wenhai YANG, Beijing (CN); Siji CHEN, Beijing (CN); Xuan LUO, Beijing (CN)

(21) Appl. No.: 19/131,784

(22) PCT Filed: Mar. 25, 2024
(86) PCT No.: PCT/CN2024/083609

§ 371 Date: May 21, 2025

(30) Foreign Application Priority Data
Apr. 4, 2023 (CN) 202310355744.4

(51) Int. Cl. G06T 3/40; G06F 3/04845; G06T 11/26

(52) U.S. Cl. CPC G06T 3/40; G06F 3/04845; G06T 11/26; G06T 2200/24

(57) ABSTRACT

A display interaction method, a device and a storage medium are provided. The method includes: in response to a scaling trigger operation in a first area of a page, acquiring a first display position corresponding to the scaling trigger operation on a displayed coordinate axis, and converting the first display position into a target coordinate axis value; expanding or reducing an original coordinate axis value range of the coordinate axis to obtain a scaled coordinate axis value range; acquiring a second display position corresponding to the target coordinate axis value in the scaled coordinate axis value range; calculating a position deviation between the first display position and the second display position; performing lateral offset on the scaled coordinate axis value range according to the position deviation to generate a first offset coordinate axis value range; and re-displaying the coordinate axis according to the first offset coordinate axis value range.

The present application claims priority of the Chinese Patent Application No. 202310355744.4, filed on Apr. 4, 2023, the disclosure of which is incorporated herein by reference in its entirety as part of the present application.

### TECHNICAL FIELD

Embodiments of the present disclosure relate to a display interaction method and apparatus, and a device.

### BACKGROUND

At present, various types of data and information may be displayed in a visual manner, so as to facilitate auxiliary analysis of various types of data and information. In the process of visual display, a user usually needs to adjust a display page, such as scaling. However, in the process of adjusting the display page by the user, the current visual display may cause visual confusion of the user and poor display effect.

### SUMMARY

In view of this, embodiments of the present disclosure provide a display interaction method and apparatus and a device, so as to improve display effect of a visual page.

To solve the above problems, the technical scheme provided by the embodiments of the present disclosure is as follows.

In a first aspect, an embodiment of the present disclosure provides a display interaction method, which includes:
in response to a scaling trigger operation in a first area of a page, acquiring a first display position corresponding to the scaling trigger operation on a displayed coordinate axis, and converting the first display position into a target coordinate axis value;
expanding or reducing an original coordinate axis value range of the coordinate axis to obtain a scaled coordinate axis value range;
acquiring a second display position corresponding to the target coordinate axis value in the scaled coordinate axis value range;
calculating a position deviation between the first display position and the second display position;
performing lateral offset on the scaled coordinate axis value range according to the position deviation to generate a first offset coordinate axis value range; and
redisplaying the coordinate axis according to the first offset coordinate axis value range.

In a second aspect, an embodiment of the present disclosure further provides a display interaction apparatus, which includes a first acquisition unit, a scaling unit, a second acquisition unit, a calculation unit, a first generation unit and a first display unit.

The first acquisition unit is configured to, in response to a scaling trigger operation in a first area of a page, acquire a first display position corresponding to a scaling trigger operation on a displayed coordinate axis, and convert the first display position into a target coordinate axis value.

The scaling unit is configured to expand or reduce an original coordinate axis value range of the coordinate axis to obtain a scaled coordinate axis value range.

The second acquisition unit is configured to acquire a second display position corresponding to the target coordinate axis value in the scaled coordinate axis value range.

The calculation unit is configured to calculate a position deviation between the first display position and the second display position.

The first generation unit is configured to perform lateral offset on the scaled coordinate axis value range according to the position deviation to generate a first offset coordinate axis value range.

The first display unit is configured to re-display the coordinate axis according to the first offset coordinate axis value range.

In a third aspect, an embodiment of the present disclosure further provides a display interaction device, which includes a memory, a processor, and a computer program that is stored on the memory and executable on the processor, where when executing the computer program, the processor implements the display interaction method as described above.

In a fourth aspect, an embodiment of the present disclosure further provides a computer-readable storage medium, where the computer-readable storage medium stores instructions, and when the instructions are executed on a terminal device, the terminal device is caused to execute the display interaction method as described above.

### BRIEF DESCRIPTION OF DRAWINGS

FIG. 1 is a schematic diagram of an exemplary application scenario provided by an embodiment of the present disclosure;

FIG. 2 is a flowchart of a display interaction method provided by an embodiment of the present disclosure;

FIG. 3 is a schematic diagram of a result of visual display of event statistical information in an embodiment of the present disclosure;

FIG. 4 is a flowchart of displaying event information in an embodiment of the present disclosure;

FIG. 5 is a schematic diagram of a result of visual display of event information in an embodiment of the present disclosure;

FIG. 6 is a schematic diagram of a result of visual display of event connection lines in an embodiment of the present disclosure;

FIG. 7 is a schematic diagram of a visual interface in an embodiment of the present disclosure;

FIG. 8 is a schematic diagram of a display interaction apparatus provided by an embodiment of the present disclosure; and

FIG. 9 is a schematic diagram of an electronic device provided by an embodiment of the present disclosure.

### DETAILED DESCRIPTION

In order to make the above objects, features and advantages of the present disclosure more apparent and understandable, the embodiments of the present disclosure will be further described in detail below with reference to the drawings and specific implementations.

At present, various types of data and information may be displayed in a visual manner, so as to facilitate auxiliary analysis of various types of data and information. In the process of visual display, a user usually needs to adjust a display page, such as scaling. However, in the process of adjusting the display page by the user, the current visual display may cause visual confusion of the user and poor display effect. In particular, for data displayed through a coordinate axis, when the user needs to perform operations such as scaling or moving on the coordinate axis, in response to the data displayed on the coordinate axis changing drastically, the user cannot view smoothly.

Based on this, embodiments of the present disclosure provide a display interaction method and apparatus and a device. When a user triggers a scaling operation, data at a position where the scaling operation is triggered remains unchanged through a manner of focus scaling, while the displayed coordinate axis is scaled, which will not cause visual confusion of the user and improve the display effect.

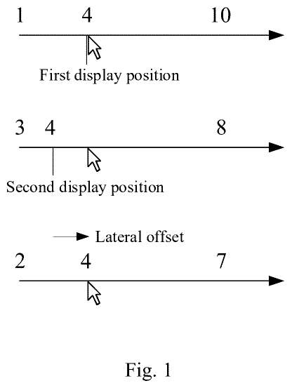

To facilitate understanding of the display interaction method provided by the embodiments of the present disclosure, the display interaction method will be described below with reference to the scenario example shown in FIG. 1. Referring to FIG. 1, FIG. 1 is a schematic diagram of an exemplary application scenario provided by an embodiment of the present disclosure.

In an embodiment of the present disclosure, in a visual page, data may be displayed based on a coordinate axis. When viewing the visual page, the user has a need to scale, move, etc. the visual page. When the user performs a scaling trigger operation in a first area of the page, for example, in an area corresponding to the coordinate axis, then a first display position corresponding to the scaling trigger operation on the displayed coordinate axis may be acquired. The first display position corresponds to a certain value on the coordinate axis, that is, a target coordinate axis value. For example, a position of a mouse cursor in FIG. 1 is the first display position corresponding to the scaling trigger operation, and a corresponding target coordinate axis value is 4.

Because the scaling trigger operation is performed, a scaled coordinate axis value range is obtained from an original coordinate axis value range of the coordinate axis. For example, a scaling-up trigger operation is performed, the original coordinate axis value range of the coordinate axis is reduced, and the scaled coordinate axis value range (3, 8) is obtained from the original coordinate axis value range (1, 10). At this time, the target coordinate axis value will have a new display position, that is, a second display position, on the scaled coordinate axis value range of the coordinate axis.

There is a position deviation between the first display position and the second display position, and the scaled coordinate axis value range is entirely laterally offset according to the position deviation to generate a first offset coordinate axis value range. For example, the first offset coordinate axis value range (2, 7) is offset from the scaled coordinate axis value range (3, 8). Finally, the coordinate axis is re-displayed according to the first offset coordinate axis value range.

In this way, after the value range of the coordinate axis changes, the target coordinate axis value is still displayed at the first display position, for example, the target coordinate axis value 4 is still displayed at the original position. The scaling effect achieved in this way is focus scaling, the scaling trigger operation is used as the center, the data at the position where the scaling operation is triggered remains unchanged, while the displayed coordinate axis is scaled, which will not cause visual confusion of the user and improve the display effect.

Those skilled in the art can understand that the framework schematic diagram shown in FIG. 1 is only an example in which the implementations of the present disclosure can be implemented. The scope of application of the implementations of the present disclosure is not limited by any aspect of the framework.

To facilitate understanding of the present disclosure, a display interaction method provided by embodiments of the present disclosure will be described below with reference to the drawings.

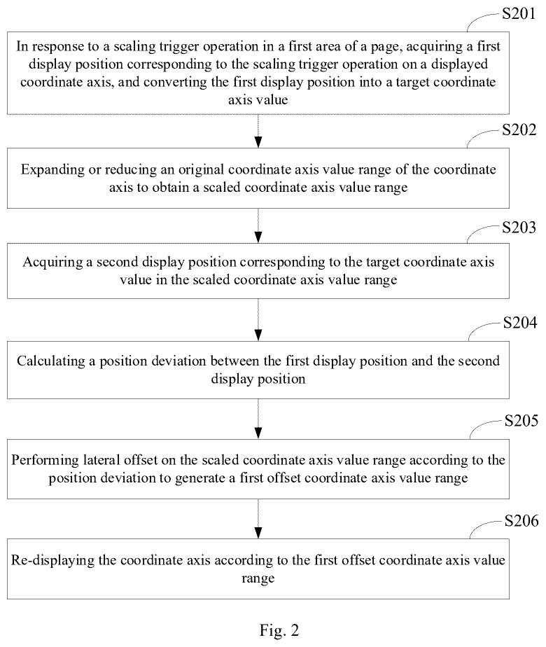

Referring to FIG. 2, FIG. 2 is a flowchart of a display interaction method provided by an embodiment of the present disclosure. As shown in FIG. 2, the method may include S201-S206.

S201: in response to a scaling trigger operation in a first area of a page, acquiring a first display position corresponding to the scaling trigger operation on a displayed coordinate axis, and converting the first display position into a target coordinate axis value.

The embodiments of the present disclosure may be applied to an electronic device that displays a visual page. In the visual page, data may be displayed based on a coordinate axis. For example, the coordinate axis is a time coordinate axis, and data with a time sequence may be displayed through the time coordinate axis. The displayed coordinate axis has a coordinate axis value range, for example, the displayed coordinate axis corresponds to data in a value range of 1-10. Meanwhile, various points on the coordinate axis have corresponding display positions. For example, the left boundary value of the current coordinate axis is 1, and the right boundary value is 10. The display position corresponding to the point of which the value is 1 on the coordinate axis is the position of the abscissa 0, and the display position corresponding to the point of which the value is 10 on the coordinate axis is the position of the abscissa 100. Therefore, various points on the coordinate axis all have corresponding display positions.

When viewing the visual page, the user has a need to scale the visual page. The user may perform a scaling trigger operation in a first area of the page. The first area of the page is an area on the page that supports the scaling trigger operation, for example, an area corresponding to the coordinate axis. In practical applications, a mouse wheel and a touch pad may be used to perform the scaling trigger operation, for example, the mouse wheel is scrolled up and down to perform the scaling trigger operation, or the touch pad is slid inward and outward to perform the scaling trigger operation. For the user, when the mouse wheel and the touch pad are used to perform the scaling trigger operation, the operation interaction path is the smallest, and no additional operations such as clicking or dragging are required to complete the scaling.

After detecting that the user performs the scaling trigger operation in the first area of the page, a first display position corresponding to the scaling trigger operation on the displayed coordinate axis may be acquired. For example, when the mouse wheel is used to perform the scaling trigger operation, a display position corresponding to a current mouse cursor on the coordinate axis, for example, the position of the abscissa 10, may be determined as the first display position.

When the coordinate axis is displayed, the display positions of various points on the coordinate axis and the corresponding coordinate axis values are known, and then the first display position may be further converted into a target coordinate axis value corresponding to the position. For example, a scale.invert( ) function is set to implement mapping from a display position to a coordinate axis value, and then mouseFocusData=scale.invert(mousePosition), where mouseFocusData is the target coordinate axis value, and mousePosition is the first display position.

S202: expanding or reducing an original coordinate axis value range of the coordinate axis to obtain a scaled coordinate axis value range.

In response to the scaling trigger operation, the original coordinate axis value range of the coordinate axis needs to be expanded or reduced. It can be understood that in a case where a display length of the coordinate axis remains unchanged, when the scaling trigger operation is a scaling-up operation, then the original coordinate axis value range of the coordinate axis needs to be reduced, and the effect of expanding the coordinate axis is achieved by displaying less data; when the scaling trigger operation is a scaling-down operation, the original coordinate axis value range of the coordinate axis needs to be expanded, and the effect of reducing the coordinate axis is achieved by displaying more data.

With the performing of the scaling trigger operation, the original coordinate axis value range of the coordinate axis may be continuously expanded or reduced. When the scaling trigger operation stops, the scaled coordinate axis value range is obtained. In practical applications, the original coordinate axis value range of the coordinate axis may be continuously expanded or reduced according to a preset time frequency until the scaling trigger operation stops. For example, a scaling-up operation is triggered by scrolling the mouse wheel upward, and then when it is detected that the mouse wheel is scrolled upward in the first area of the page, the original coordinate axis value range of the coordinate axis is continuously reduced according to the preset time frequency until the scrolling of the mouse wheel upward stops. The preset time frequency may be set according to the actual situation, and the embodiments of the present disclosure do not limit the value of the preset time frequency.

In a possible implementation, the specific implementation of S202: expanding or reducing the original coordinate axis value range of the coordinate axis to obtain the scaled coordinate axis value range may include the following steps.
A1: when the scaling trigger operation is a scaling-up operation, multiplying a left boundary value of the original coordinate axis value range of the coordinate axis by a first coefficient to obtain a left boundary value of the scaled coordinate axis value range, and multiplying a right boundary value of the original coordinate axis value range of the coordinate axis by a second coefficient to obtain a right boundary value of the scaled coordinate axis value range, where the first coefficient is greater than 1, and the second coefficient is less than 1.

When the scaling trigger operation is a scaling-up operation, the left boundary value of the original coordinate axis value range of the coordinate axis may be multiplied by the first coefficient that is greater than 1, and the right boundary value of the original coordinate axis value range of the coordinate axis may be multiplied by the second coefficient that is less than 1, to obtain the scaled coordinate axis value range. Thus, the original coordinate axis value range of the coordinate axis is reduced, for example, the scaled coordinate axis value range (3, 8) is obtained from the original coordinate axis value range (1, 10). The first coefficient and the second coefficient may be set according to the actual situation, and the values of the first coefficient and the second coefficient are not limited in the embodiments of the present disclosure.

In practical applications, a scale.domain two-dimensional array may be set to store coordinate axis values of the coordinate axis, and scale.domain[0] stores the left boundary value of the coordinate axis value range, and scale.domain[1] stores the right boundary value of the coordinate axis value range. When the scaling trigger operation is a scaling-up operation, for example, the first coefficient is 1.00001, and the second coefficient is 0.99999, scale.domain[0 ] and scale.domain[1] may be updated by: scale.domain[0]=scale.domain[0]*1.00001, scale.domain[1]=scale.domain[1]*0.99999, so as to reduce the coordinate axis value range, and the scaled coordinate axis value range is obtained from the original coordinate axis value range.
A2: when the scaling trigger operation is a scaling-down operation, multiplying the left boundary value of the original coordinate axis value range of the coordinate axis by a third coefficient to obtain the left boundary value of the scaled coordinate axis value range, and multiplying the right boundary value of the original coordinate axis value range of the coordinate axis by a fourth coefficient to obtain the right boundary value of the scaled coordinate axis value range, where the third coefficient is less than 1, and the fourth coefficient is greater than 1.

When the scaling trigger operation is a scaling-down operation, the left boundary value of the original coordinate axis value range of the coordinate axis may be multiplied by the third coefficient that is less than 1, and the right boundary value of the original coordinate axis value range of the coordinate axis may be multiplied by the fourth coefficient that is greater than 1, to obtain the scaled coordinate axis value range. Thus, the original coordinate axis value range of the coordinate axis is expanded, for example, the scaled coordinate axis value range (1, 11) is obtained from the original coordinate axis value range (2, 10). The third coefficient and the fourth coefficient may be set according to the actual situation, and the values of the third coefficient and the fourth coefficient are not limited in the embodiments of the present disclosure.

In practical applications, a scale.domain two-dimensional array may be set to store coordinate axis values of the coordinate axis, and scale.domain[0] stores the left boundary value of the coordinate axis value range, and scale.domain[1] stores the right boundary value of the coordinate axis value range. When the scaling trigger operation is a scaling-down operation, for example, the third coefficient is 0.99999, and the fourth coefficient is 1.00001, scale.domain[0] and scale.domain[1] may be updated by: scale.domain[0]=scale.domain[0]*0.99999, scale.domain[1]=scale.domain[1]*1.00001, so as to expand the coordinate axis value range, and the scaled coordinate axis value range is obtained from the original coordinate axis value range.

With the performing of the scaling trigger operation, A1-A2 may be repeatedly executed until the scaling trigger operation stops, to obtain a final scaled coordinate axis value range.

S203: acquiring a second display position corresponding to the target coordinate axis value in the scaled coordinate axis value range.

After the scaled coordinate axis value range is obtained, the target coordinate axis value will have a new position, that is, a second display position, in the scaled coordinate axis value range. When the coordinate axis is displayed, the coordinate axis values of various points on the coordinate axis and the corresponding display positions are known, and then the target coordinate axis value may be converted into the second display position corresponding to the scaled coordinate axis value range. For example, a scale.scale( ) function is set to implement mapping from a coordinate axis value to a display position, and the second display position is scale.scale(mouseFocusData), where mouseFocusData is the target coordinate axis value.

S204: calculating a position deviation between the first display position and the second display position.

There is a position deviation between the first display position and the second display position, and the position deviation may be obtained by subtracting the two positions. For example, deltaOffset=scale.scale(mouseFocusData)−mousePosition, where deltaOffset is the position deviation, scale.scale(mouseFocusData) is the second display position, and mousePosition is the first display position.

S205: performing lateral offset on the scaled coordinate axis value range according to the position deviation to generate a first offset coordinate axis value range.

S206: re-displaying the coordinate axis according to the first offset coordinate axis value range.

In order to eliminate the position deviation, with the target of moving the target coordinate axis value from the second display position to the first display position, the scaled coordinate axis value range is entirely laterally offset to re-determine the coordinate axis value range, that is, the first offset coordinate axis value range. Finally, the display of the coordinate axis is refreshed according to the first offset coordinate axis value range. Thus, after the value range of the coordinate axis changes, the target coordinate axis value may still be displayed at the first display position.

Based on the description of S201-S206, in the embodiment of the present disclosure, the first display position corresponding to the scaling trigger operation on the displayed coordinate axis is acquired in response to the scaling trigger operation in the first area of the page, and the first display position is converted into the target coordinate axis value. Meanwhile, in response to the scaling trigger operation, the original coordinate axis value range of the coordinate axis may be expanded or reduced to obtain the scaled coordinate axis value range. In the scaled coordinate axis value range, the target coordinate axis value corresponds to a new position, that is, the second display position, and there is a position deviation between the first display position and the second display position. The scaled coordinate axis value range is entirely laterally offset according to the position deviation to generate the first offset coordinate axis value range, and the coordinate axis is re-displayed according to the first offset coordinate axis value range. Thus, after the value range of the coordinate axis changes, the target coordinate axis value is still displayed at the first display position. The scaling effect achieved in this way is focus scaling, the scaling trigger operation is used as the center, the data at the position where the scaling operation is triggered remains unchanged, while the displayed coordinate axis is scaled, which will not cause visual confusion of the user and improve the display effect.

The user may also perform a lateral moving trigger operation on the visual page. In some possible implementations, the display interaction method provided by the embodiments of the present disclosure may further include the following steps.
B1: performing lateral offset on the original coordinate axis value range of the coordinate axis to generate a second offset coordinate axis value range in response to a lateral moving trigger operation in the first area of the page or a second area of the page.

When viewing the visual page, the user has a need to perform a lateral moving operation on the visual page. The user may perform the lateral moving trigger operation in the first area of the page or a second area of the page. The second area of the page is an area on the page other than the first area of the page. In practical applications, a mouse and a touch pad may be used to perform the lateral moving trigger operation, for example, the mouse is left-clicked and right-clicked to perform the lateral moving trigger operation, or the touch pad is slid leftward and rightward to perform the lateral moving trigger operation.

After detecting that the user performs the lateral moving trigger operation in the first area of the page or the second area of the page, the original coordinate axis value range of the coordinate axis may be entirely laterally offset according to a moving direction indicated by the lateral moving trigger operation, to generate a second offset coordinate axis value range. For example, the moving direction indicated by the lateral moving trigger operation is moving rightward, and the second offset coordinate axis value range (1, 9) is obtained from the original coordinate axis value range (2, 10). The moving direction indicated by the lateral moving trigger operation is moving rightward, and the second offset coordinate axis value range (3, 11) is obtained from the original coordinate axis value range (2, 10).
B2: re-displaying the coordinate axis according to the second offset coordinate axis value range.

Finally, the display of the coordinate axis is refreshed according to the second offset coordinate axis value range, so as to achieve the display effect of translating the coordinate axis.

In the embodiment of the present disclosure, the displayed coordinate axis may be displayed with corresponding lateral translation in response to the lateral moving trigger operation.

In an application scenario, in various types of applications, event information that has a time sequence is usually generated. For example, in social applications, event information recording user behaviors may be generated. For example, in a social application, when a user A logs in, event information recording a login event of the user A will be generated. When the user A sends a private message to a user B and the user B receives the private message sent by the user A, event information recording a private message communication event between the user A and the user B will be generated, and so on. Meanwhile, event statistical information that has a time sequence will also be generated, and the event statistical information represents the event occurrence total number of events of a certain type that occur in a certain time period. Embodiments of the present disclosure are capable of visually presenting the event information and/or the event statistical information of the user. Therefore, in the above embodiments, the coordinate axis may be a time coordinate axis, and a coordinate axis value range of the time coordinate axis corresponds to a range of time. That is, the time may be converted into a value to be displayed through the time coordinate axis.

In the embodiment of the present disclosure, in the process of scaling and laterally translating the time coordinate axis, with the re-display of the time coordinate axis, the histogram corresponding to the event statistical information and/or the event time axis corresponding to the event information may also be re-displayed following the change of the time coordinate axis. To facilitate understanding, the display of the histogram corresponding to the event statistical information will be explained first.

In the embodiment of the present disclosure, the event statistical information may be acquired, and the event statistical information represents the event occurrence total number of events of a certain type in a certain time period. Therefore, the event statistical information includes an event type, start time, end time, and the event occurrence total number. The start time and the end time are the start time and the end time of a certain time period, and the event occurrence total number is the event occurrence total number of events corresponding to a certain event type generated by various users in the certain time period. For example, from 0:00 to 1:00 on a certain day, the event occurrence total number of registration events is 10,000, then the event statistical information includes the event type: registration event, the start time is 0:00 on a certain day, the end time is 1:00 on a certain day, and the event occurrence total number is 10,000.

In practical applications, a plurality of pieces of event statistical information may represent the event occurrence total numbers of events corresponding to a plurality of event types in a plurality of time periods, respectively. For example, the event statistical information 1 includes the event occurrence total number of registration events in the time period 1, the event statistical information 2 includes the event occurrence total number of comment events in the time period 1, the event statistical information 3 includes the event occurrence total number of registration events in the time period 2, and the event statistical information 4 includes the event occurrence total number of comment events in the time period 2, and so on.

The time coordinate axis is triggered to be displayed, and the time coordinate axis is used as the time basis for display. Meanwhile, the histogram corresponding to the event statistical information may also be triggered to be displayed, and the event statistical information is displayed through the histogram. Each histogram corresponds to the event statistical information of the same event type, for example, the histogram 1 corresponds to the event statistical information of the registration event type, and the histogram 2 corresponds to the event statistical information of the comment event type.

Each histogram includes at least one column structure, the histogram includes at least one column structure, a start point of the column structure corresponds to the start time in the event statistical information and is aligned with corresponding time in the time coordinate axis, an end point of the column structure corresponds to the end time in the event statistical information and is aligned with corresponding time in the time coordinate axis, and a height of the column structure corresponds to the event occurrence total number in the event statistical information. That is, the column structure represents the event occurrence total number of events of a certain type in a certain time period. That is, the column structure corresponds to one piece of event statistical information, the start time and the end time in the event statistical information are converted into the start point and the end point of the column structure through time mapping, the start point of the column structure may be understood as the left boundary of the column structure, and the end point of the column structure may be understood as the right boundary of the column structure. The start time and the end time marked by the start point and the end point of the column structure are aligned with corresponding time in the time coordinate axis. The event occurrence total number in the event statistical information is converted into the height of the column structure through linear mapping.

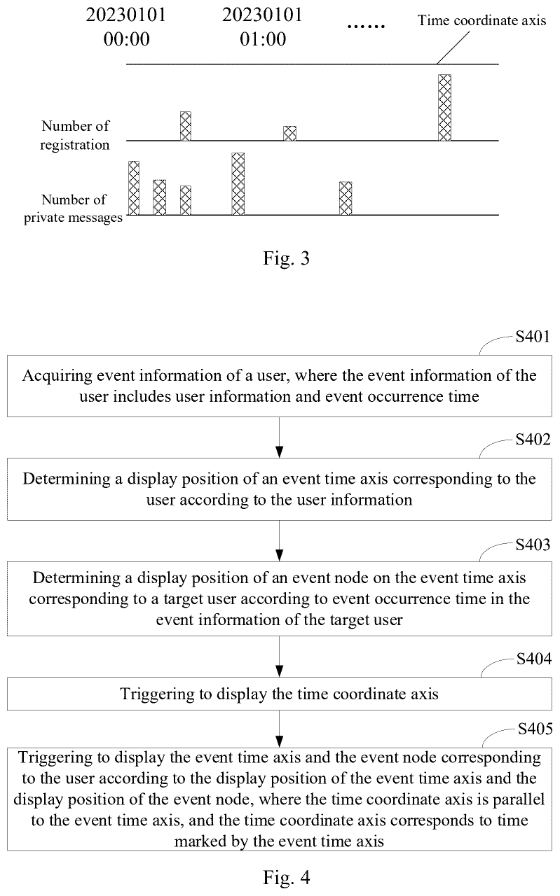

Referring to FIG. 3, FIG. 3 shows a schematic diagram of a result of visual display of the event statistical information. For example, while the time coordinate axis is triggered to be displayed, two histograms are displayed, which respectively correspond to the event statistical information of the registration event type and the event statistical information of the private message event type. Through the column structure in the histogram, the event occurrence total number in the corresponding time period may be displayed visually.

In the embodiment of the present disclosure, the event time axis corresponding to the event information may also be displayed. Referring to FIG. 4, FIG. 4 shows a flowchart of displaying the event information, which includes the following steps.

S401: acquiring event information of a user, where the event information of the user includes user information and event occurrence time.

The embodiments of the present disclosure may be applied to an electronic device that triggers the display of the event information. In the embodiments of the present disclosure, it is first necessary to acquire the event information of the user. The event information is used to record relevant information of various events that generate user behaviors. The event information of the user includes user information, such as a user identification, a user IP address, etc., and the event information of the user may further include an event type and a corresponding event occurrence time. In one piece of event information, the event occurrence time of one or more events corresponding to one user may be recorded, and the plurality of events may be events of different types or the same type. The event occurrence time may be represented by using a timestamp.

When a plurality of pieces of different event information of the same user are acquired, the plurality of pieces of different event information of the same user may also be merged according to the event occurrence time therein, so that one user corresponds to one piece of event information.

In addition, in a possible implementation, the event information of the user further includes relationship information between events. Different events of different users may have relationships. For example, a private message sending event of a certain user has a relationship with a private message receiving event of another user.

Exemplary description is made to the event information of the user. For example, when the user A logs in, the event information 1 records the user information of the user A and the event occurrence time of the login event. When the user A sends a private message to the user B and the user B receives the private message sent by the user A, the event information 2 records the user information of the user A, the event occurrence time of the private message sending event, and the related user of the private message sending event being the user B. The event information 3 will record the user information of the user B, the event occurrence time of the private message receiving event, and the related user of the private message receiving event being the user A. The user information in the event information 1 and the event information 2 is the user A, and thus the event information 1 and the event information 2 may be merged into one piece of event information. The merged event information 1′ records the user information of the user A, the event occurrence time of the login event, the event occurrence time of the private message sending event, and the related user of the private message sending event being the user B. The private message sending event and the private message receiving event may belong to the same event type of the private message communication event.

S402: determining a display position of an event time axis corresponding to the user according to the user information.

The user information in the event information of the user is distinguished, and a display position of a corresponding event time axis is allocated to each user. Generally, each user corresponds to one event time axis, and the event time axis is used to mark the event occurrence time of an event related to the user.

In practical applications, the interval between various event time axes may be determined according to the actual display situation, so as to determine the display position of the event time axis. For example, the event time axis is parallel to the horizontal direction, and the various event time axes are arranged longitudinally. The interval between the various event time axes is 5 display units (such as 5 pixels). The first event time axis is displayed at the position of the ordinate 0, the second event time axis is displayed at the position of the ordinate 5, and so on. The position of each event time axis from left to right may be marked with the time, and the time marked on the event time axis is consistent with the time marked at the same position on the time coordinate axis.

S403: determining a display position of an event node on the event time axis corresponding to a target user according to event occurrence time in the event information of the target user, where the target user is any one of users.

The target user is any one of the users. For the target user, the display position of the event node corresponding to each event on the event time axis of the target user may be determined according to the event occurrence time of each event in the event information of the target user. The display position of the event node is consistent with the time marked at the same position on the time coordinate axis. In practical applications, the time marked at each position of the displayed time coordinate axis may be set, and then the corresponding display position of the event node corresponding to the event on the event time axis may be determined according to the event occurrence time of the event.

S404: triggering to display the time coordinate axis.

S405: triggering to display the event time axis and the event node corresponding to the user according to the display position of the event time axis and the display position of the event node, where the time coordinate axis is parallel to the event time axis, and the time coordinate axis corresponds to time marked by the event time axis.

When visual display is required, the time coordinate axis, the event time axis and the event node may be triggered to be displayed at the same time. In practical applications, the event time axis corresponding to each user and the event node on each event time axis are triggered to be displayed according to the determined display position of the event time axis and the determined display position of the event node. The event time axis is parallel to the time coordinate axis, the time marked at the same position on the time coordinate axis is consistent with the time marked on the event time axis, and the time coordinate axis is used as the time basis for display. Through the position of the event node of the event on the event time axis, the occurrence time of the event may be displayed visually.

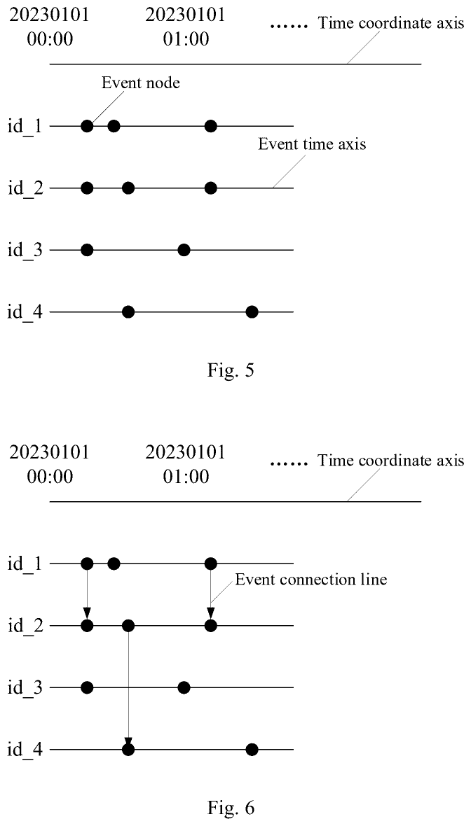

Referring to FIG. 5, FIG. 5 shows a schematic diagram of a result of visual display of the event information. Assuming that there are 4 users, the event time axis corresponding to each user is triggered to be displayed according to the determined display position of the event time axis, and the time coordinate axis is simultaneously triggered to be displayed as the time basis. In FIG. 5, the black dots represent the event nodes, and each event node corresponds to one event. The event node may be displayed on the event time axis according to the display position of the event node. Thus, the time corresponding to the event node may be displayed visually through the time coordinate axis.

Since the event information of the user may further include the relationship information between the events, the embodiments of the present disclosure may also display the relationship between the events visually.

After the event time axis and the event node are triggered to be displayed, the event nodes of which an association exists between different users may be determined according to the relationship information between the events. The event nodes of which an association exists between different users usually have the same event occurrence time. For example, at 0:00 on a certain day, the user A sends a private message to the user B, and at the same time, the user B receives the private message sent by the user A. The user A has a private message sending event node a, and the event occurrence time is 0:00 on a certain day. The user B has a private message receiving event node b, and the event occurrence time is 0:00 on a certain day. The private message sending event node a and the private message receiving event node b are the event nodes of which an association exists between different users.

According to the positions of the event nodes of which an association exists, the start point and the end point of the event connection line may be determined, and the event connection line may connect the event nodes of which an association exists. Thus, the display of the event connection lines between the event nodes of which an association exists is triggered.

Referring to FIG. 6, FIG. 6 shows a schematic diagram of a result of visual display of the event connection lines. For example, the first event node of the user id_1 and the first event node of the user id_2 are the event nodes of which an association exists, and an event connection line is displayed between the two event nodes. The second event node of the user id_2 and the first event node of the user id_4 are the event nodes of which an association exists, and an event connection line is displayed between the two event nodes, and so on.

Based on the above description, in a possible implementation, the display interaction method provided by the embodiments of the present disclosure may further include:
re-displaying the displayed histogram corresponding to the event statistical information with the re-display of the coordinate axis.

When the coordinate axis is the time coordinate axis, with the performing of the scaling trigger operation or the lateral moving trigger operation, after the time coordinate axis is re-displayed, the displayed histogram corresponding to the event statistical information is also re-displayed following the change of the time coordinate axis. That is, when the time range corresponding to the time coordinate axis changes, the histogram corresponding to the event statistical information also changes accordingly, so that the start point of the column structure corresponds to the start time in the event statistical information and is aligned with the corresponding time in the time coordinate axis, and the end point of the column structure corresponds to the end time in the event statistical information and is aligned with corresponding time in the time coordinate axis.

In a possible implementation, the display interaction method provided by the embodiments of the present disclosure may further include:
re-displaying the displayed event time axis corresponding to the event information with the re-display of the coordinate axis, where the time coordinate axis is parallel to the event time axis, and the time coordinate axis corresponds to the time marked by the event time axis.

Similarly, when the coordinate axis is the time coordinate axis, with the performing of the scaling trigger operation or the lateral moving trigger operation, after the time coordinate axis is re-displayed, the displayed event time axis is also re-displayed following the change of the time coordinate axis. That is, when the time range corresponding to the time coordinate axis changes, the time range corresponding to the event time axis also changes accordingly.

In a possible implementation, the event node is displayed on the event time axis, and the display position of the event node corresponds to the event occurrence time in the event information.

That is, when the time range corresponding to the time coordinate axis changes, the time range corresponding to the event time axis also changes accordingly, which can ensure that the event occurrence time corresponding to the event information on the event time axis is still aligned with corresponding time in the time coordinate axis.

Thus, in the embodiments of the present disclosure, when the time coordinate axis is displayed, and the histogram corresponding to the event statistical information and/or the event time axis corresponding to the event information is displayed through the time coordinate axis, with the scaling or lateral moving of the time coordinate axis, the histogram corresponding to the event statistical information and/or the event time axis corresponding to the event information may be re-displayed following the change of the time coordinate axis, thus achieving the interactive display process of the visual page.

In addition, since there are a large number of event time axes, the user may also perform a longitudinal moving trigger operation on the display region where the event time axes in the visual page are located. In some possible implementations, the display interaction method provided by the embodiments of the present disclosure may further include the following steps.
C1: performing longitudinal offset on a longitudinal display position of the event time axis to re-determine the longitudinal display position of the event time axis in response to a longitudinal moving trigger operation in a second area of the page.

When viewing the visual page, the user has a need to perform a longitudinal moving operation on the display region where the event time axes are located. The user may perform the longitudinal moving trigger operation in the second area of the page. The mouse and the touch pad may be used to perform the longitudinal moving trigger operation, for example, the mouse wheel is scrolled up and down to perform the longitudinal moving trigger operation, or the touch pad is slid up and down to perform the longitudinal moving trigger operation.

After detecting that the user performs the longitudinal moving trigger operation in the second area of the page, the longitudinal display position of the event time axis may be longitudinally offset according to a moving direction indicated by the longitudinal moving trigger operation, to re-determine the longitudinal display position of the event time axis. For example, the moving direction indicated by the longitudinal moving trigger operation is moving upward, and the longitudinal display position of each event time axis is moved upward to re-determine the longitudinal display position of the event time axis.
C2: re-displaying the event time axis according to the longitudinal display position of the event time axis.

Finally, the event time axis is re-displayed according to the updated longitudinal display position of the event time axis, so as to achieve the display effect of translating the event time axis longitudinally.

In the embodiment of the present disclosure, the displayed event time axis may be performed corresponding longitudinal translation display in response to the longitudinal moving trigger operation.

Since the mouse wheel scrolling up and down may correspond to either the scaling trigger operation or the longitudinal moving trigger operation, in order to prevent co-triggering of scaling and longitudinal moving, only in the first area of the page, the mouse wheel scrolling up and down may perform the scaling trigger operation, and only in the second area of the page, the mouse wheel scrolling up and down may perform the longitudinal moving trigger operation.

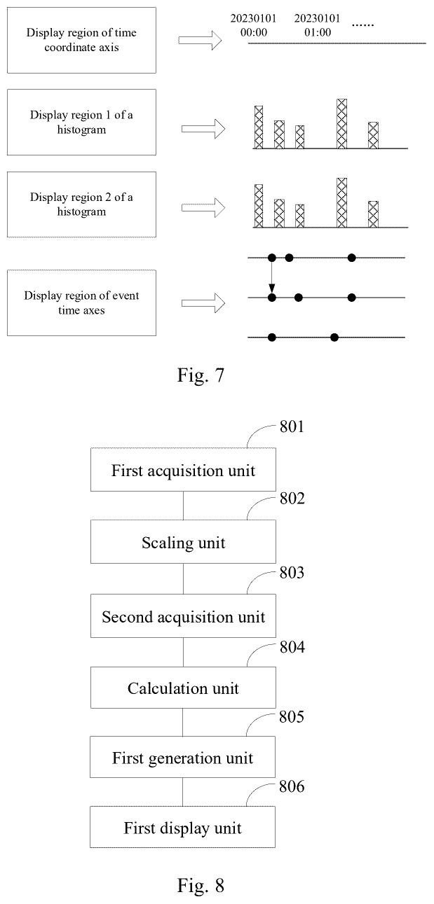

In the scenario of displaying the event information and/or the event statistical information of the user, referring to FIG. 7, FIG. 7 shows a schematic diagram of a visual interface. In the visual interface, the time coordinate axis is in one display region, each histogram is in one display region, and the various event time axes are in one display region. The display region of the time coordinate axis and the display region of the histogram may be the first area of the page, and the display region of the event time axes may be the second area of the page. Thus, the scaling trigger operation may be performed only in the first area of the page, and the longitudinal moving trigger operation may be performed only in the second area of the page.

Based on the display interaction method provided by the above method embodiments, an embodiment of the present disclosure further provides a display interaction apparatus, which will be described below with reference to the drawings.

Referring to FIG. 8, FIG. 8 is a schematic structural diagram of a display interaction apparatus provided by an embodiment of the present disclosure. As shown in FIG. 8, the display interaction apparatus includes a first acquisition unit 801, a scaling unit 802, a second acquisition unit 803, a calculation unit 804, a first generation unit 805 and a first display unit 806.

The first acquisition unit 801 is configured to, in response to a scaling trigger operation in a first area of a page, acquire a first display position corresponding to the scaling trigger operation on a displayed coordinate axis, and convert the first display position into a target coordinate axis value.

The scaling unit 802 is configured to expand or reduce an original coordinate axis value range of the coordinate axis to obtain a scaled coordinate axis value range.

The second acquisition unit 803 is configured to acquire a second display position corresponding to the target coordinate axis value in the scaled coordinate axis value range.

The calculation unit 804, configured to calculate a position deviation between the first display position and the second display position.

The first generation unit 805 is configured to perform lateral offset on the scaled coordinate axis value range according to the position deviation to generate a first offset coordinate axis value range.

The first display unit 806 is configured to re-display the coordinate axis according to the first offset coordinate axis value range.

In a possible implementation, the scaling unit includes a scaling-up subunit and a scaling-down subunit.

The scaling-up subunit is configured to, when the scaling trigger operation is a scaling-up operation, multiply a left boundary value of the original coordinate axis value range of the coordinate axis by a first coefficient to obtain a left boundary value of the scaled coordinate axis value range, and multiply a right boundary value of the original coordinate axis value range of the coordinate axis by a second coefficient to obtain a right boundary value of the scaled coordinate axis value range, where the first coefficient is greater than 1, and the second coefficient is less than 1.

The scaling-down subunit is configured to, when the scaling trigger operation is a scaling-down operation, multiply the left boundary value of the original coordinate axis value range of the coordinate axis by a third coefficient to obtain the left boundary value of the scaled coordinate axis value range, and multiply the right boundary value of the original coordinate axis value range of the coordinate axis by a fourth coefficient to obtain the right boundary value of the scaled coordinate axis value range, where the third coefficient is less than 1, and the fourth coefficient is greater than 1.

In a possible implementation, the apparatus further includes a second generation unit and a second display unit.

The second generation unit is configured to perform lateral offset on the original coordinate axis value range of the coordinate axis to generate a second offset coordinate axis value range in response to a lateral moving trigger operation in the first area of the page or a second area of the page.

The second display unit is configured to re-display the coordinate axis according to the second offset coordinate axis value range.

In a possible implementation, the coordinate axis is a time coordinate axis, and a coordinate axis value range of the time coordinate axis corresponds to a range of time, and the apparatus further includes a third display unit.

The third display unit is configured to re-display a displayed histogram corresponding to event statistical information with re-display of the coordinate axis, where each histogram corresponds to event statistical information of a same event type, the histogram includes at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an event occurrence total number in the event statistical information.

In a possible implementation, the coordinate axis is a time coordinate axis, a coordinate axis value range of the time coordinate axis corresponds to a range of time, and the apparatus further includes a fourth display unit.

The fourth display unit is configured to re-display a displayed event time axis corresponding to event information with re-display of the coordinate axis, where the time coordinate axis is parallel to the event time axis, and the time coordinate axis corresponds to time marked by the event time axis.

In a possible implementation, an event node is displayed on the event time axis, and a display position of the event node corresponds to event occurrence time in the event information.

In a possible implementation, the apparatus further includes a determination unit and a fifth display unit.

The determination unit is configured to perform longitudinal offset on a longitudinal display position of the event time axis to re-determine the longitudinal display position of the event time axis in response to a longitudinal moving trigger operation in a second area of the page.

The fifth display unit is configured to re-display the event time axis according to the longitudinal display position of the event time axis.

Based on the display interaction method provided by the above method embodiments, the present disclosure further provides an electronic device, including: one or more processors; a memory, on which one or more programs are stored. When the one or more programs are executed by the one or more processors, the one or more processors are caused to implement the display interaction method according to any of the above embodiments.

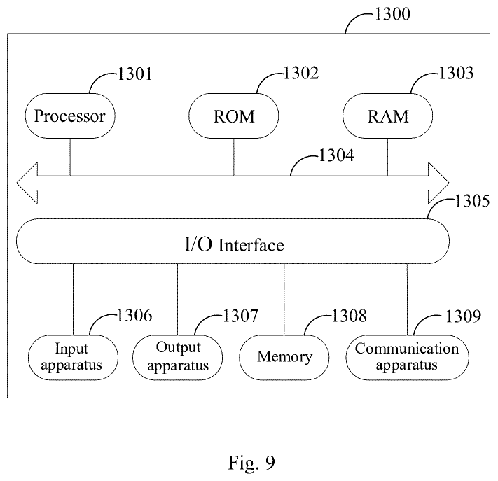

Reference is made to FIG. 9 below, FIG. 9 illustrates a schematic structural diagram of an electronic device 1300 suitable for implementing the embodiments of the present disclosure. The terminal device in the embodiments of the present disclosure may include, but is not limited to, a mobile terminal such as a mobile phone, a notebook computer, a digital broadcast receiver, a PDA (Personal Digital Assistant), a PAD (portable android device), a PMP (Portable Media Player), a vehicle-mounted terminal (such as a vehicle navigation terminal), and a fixed terminal such as a digital TV (television) and a desktop computer. The electronic device shown in FIG. 9 is only an example, and should not impose any limitation to the function and scope of use of the embodiments of the present disclosure.

As shown in FIG. 9, the electronic device 1300 may include a processor (such as a central processing unit, a graphics processor, etc.) 1301, which may perform various appropriate actions and processing according to a program stored in a read-only memory (ROM) 1302 or a program loaded from a memory 1306 into a random access memory (RAM) 1303. The RAM 1303 also stores various programs and data required for the operation of the electronic device 1300. The processor 1301, the ROM 1302, and the RAM 1303 are connected to each other through a bus 1304. An input/output (I/O) interface 1305 is also connected to the bus 1304.

Generally, the following apparatus may be connected to the I/O interface 1305: an input apparatus 1306 including, for example, a touch screen, a touch pad, a keyboard, a mouse, a camera, a microphone, an accelerometer, a gyroscope, etc.; an output apparatus 1307 including, for example, a liquid crystal display (LCD), a speaker, a vibrator, etc. ; a memory 1306 including, for example, a magnetic tape, a hard disk, etc.; and a communication apparatus 1309. The communication apparatus 1309 may allow the electronic device 1300 to perform wireless or wired communication with other devices to exchange data. Although FIG. 9 shows the electronic device 1300 having various apparatus, it should be understood that not all of the illustrated apparatus are required to be implemented or provided. Alternatively, more or fewer apparatus may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program contains program codes for executing the methods shown in the flowcharts. In such an embodiment, the computer program may be downloaded from the network and installed through the communication apparatus 1309, or installed from the memory 1306, or installed from the ROM 1302. When the computer program is executed by the processor 1301, the above functions defined in the methods of the embodiments of the present disclosure are executed.

The electronic device provided by the embodiments of the present disclosure belongs to the same inventive concept as the display interaction method provided by the above embodiments. For the technical details not described in detail in this embodiment, reference may be made to the above embodiments, and this embodiment has the same beneficial effects as the above embodiments.

Based on the display interaction method provided by the above method embodiments, an embodiment of the present disclosure provides a computer-readable medium, on which a computer program is stored, and when the program is executed by a processor, the display interaction method according to any of the above embodiments is implemented.

It should be noted that the above-mentioned computer-readable medium of the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the embodiments of the present disclosure, the computer-readable storage medium may be any tangible medium that contains or stores a program that can be used by or in combination with an instruction execution system, apparatus or device. In the present disclosure, however, the computer-readable signal medium may include a data signal propagated in baseband or as part of a carrier wave, in which computer-readable program codes are carried. Such propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus or device. The program codes contained in the computer-readable medium may be transmitted by any suitable medium, including but not limited to an electrical wire, an optical cable, a radio frequency (RF), etc., or any suitable combination thereof.

In some implementations, clients and servers may communicate using any currently known or future-developed network protocol, such as the Hypertext Transfer Protocol (HTTP), and may be interconnected with any form or medium of digital data communication (for example, a communication network). Examples of the communication network include a local area network (“LAN”), a wide area network (“WAN”), an internetwork (for example, the Internet), and an end-to-end network (for example, an ad hoc end-to-end network), as well as any currently known or future-developed network.

The above computer-readable medium may be included in the above electronic device; or may also exist alone without being assembled into the electronic device.

The above computer-readable medium carries one or more programs, and when the above one or more programs are executed by the electronic device, the electronic device is caused to execute the above display interaction method.

The computer program codes for executing the operations in the embodiments of the present disclosure may be written in one or more programming languages or a combination thereof. The above programming languages include but are not limited to object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or server. In the case of involving a remote computer, the remote computer may be connected to the user's computer through any kind of network, including a local area network (LAN) or a wide area network (WAN), or may be connected to an external computer (for example, connected via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, which contains one or more executable instructions for implementing specified logical functions. It should also be noted that, in some alternative implementations, the functions noted in the blocks may also occur in an order different from those noted in the drawings. For example, two blocks shown in succession may, in fact, be executed substantially concurrently, or may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit/module does not constitute a limitation of the unit itself under certain circumstances.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the embodiments of the present disclosure, the machine-readable medium may be a tangible medium that may contain or store programs for use by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a display interaction method, which includes:
in response to a scaling trigger operation in a first area of a page, acquiring a first display position corresponding to the scaling trigger operation on a displayed coordinate axis, and converting the first display position into a target coordinate axis value;
expanding or reducing an original coordinate axis value range of the coordinate axis to obtain a scaled coordinate axis value range;
acquiring a second display position corresponding to the target coordinate axis value in the scaled coordinate axis value range;
calculating a position deviation between the first display position and the second display position;
performing lateral offset on the scaled coordinate axis value range according to the position deviation to generate a first offset coordinate axis value range; and
re-displaying the coordinate axis according to the first offset coordinate axis value range.

According to one or more embodiments of the present disclosure, Example 2 provides a display interaction method, where the expanding or reducing an original coordinate axis value range of the coordinate axis to obtain a scaled coordinate axis value range, includes:
when the scaling trigger operation is a scaling-up operation, multiplying a left boundary value of the original coordinate axis value range of the coordinate axis by a first coefficient to obtain a left boundary value of the scaled coordinate axis value range, and multiplying a right boundary value of the original coordinate axis value range of the coordinate axis by a second coefficient to obtain a right boundary value of the scaled coordinate axis value range, where the first coefficient is greater than 1, and the second coefficient is less than 1; and
when the scaling trigger operation is a scaling-down operation, multiplying the left boundary value of the original coordinate axis value range of the coordinate axis by a third coefficient to obtain the left boundary value of the scaled coordinate axis value range, and multiplying the right boundary value of the original coordinate axis value range of the coordinate axis by a fourth coefficient to obtain the right boundary value of the scaled coordinate axis value range, where the third coefficient is less than 1, and the fourth coefficient is greater than 1.

According to one or more embodiments of the present disclosure, Example 3 provides a display interaction method, where the method further includes:
performing lateral offset on the original coordinate axis value range of the coordinate axis to generate a second offset coordinate axis value range in response to a lateral moving trigger operation in the first area of the page or a second area of the page; and
re-displaying the coordinate axis according to the second offset coordinate axis value range.

According to one or more embodiments of the present disclosure, Example 4 provides a display interaction method, where the coordinate axis is a time coordinate axis, and a coordinate axis value range of the time coordinate axis corresponds to a range of time, and the method further includes:
re-displaying a displayed histogram corresponding to event statistical information with re-display of the coordinate axis, where each histogram corresponds to event statistical information of a same event type, the histogram includes at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an event occurrence total number in the event statistical information.

According to one or more embodiments of the present disclosure, Example 5 provides a display interaction method, where the coordinate axis is a time coordinate axis, and a coordinate axis value range of the time coordinate axis corresponds to a range of time, and the method further includes:
re-displaying a displayed event time axis corresponding to event information with re-display of the coordinate axis, where the time coordinate axis is parallel to the event time axis, and the time coordinate axis corresponds to time marked by the event time axis.

According to one or more embodiments of the present disclosure, Example 6 provides a display interaction method, where an event node is displayed on the event time axis, and a display position of the event node corresponds to event occurrence time in the event information.

According to one or more embodiments of the present disclosure, Example 7 provides a display interaction method, where the method further includes:
performing longitudinal offset on a longitudinal display position of the event time axis to re-determine the longitudinal display position of the event time axis in response to a longitudinal moving trigger operation in a second area of the page; and
re-displaying the event time axis according to the longitudinal display position of the event time axis.

According to one or more embodiments of the present disclosure, Example 8 provides a display interaction apparatus, which includes a first acquisition unit, a scaling unit, a second acquisition unit, a calculation unit, a first generation unit and a first display unit.

The first acquisition unit is configured to, in response to a scaling trigger operation in a first area of a page, acquire a first display position corresponding to the scaling trigger operation on a displayed coordinate axis, and convert the first display position into a target coordinate axis value.

The scaling unit is configured to expand or reduce an original coordinate axis value range of the coordinate axis to obtain a scaled coordinate axis value range.

The second acquisition unit is configured to acquire a second display position corresponding to the target coordinate axis value in the scaled coordinate axis value range.

The calculation unit is configured to calculate a position deviation between the first display position and the second display position.

The first generation unit is configured to perform lateral offset on the scaled coordinate axis value range according to the position deviation to generate a first offset coordinate axis value range.

The first display unit is configured to re-display the coordinate axis according to the first offset coordinate axis value range.

According to one or more embodiments of the present disclosure, Example 9 provides a display interaction apparatus, where the scaling unit includes a scaling-up subunit and a scaling-down subunit.

The scaling-up subunit is configured to, when the scaling trigger operation is a scaling-up operation, multiply a left boundary value of the original coordinate axis value range of the coordinate axis by a first coefficient to obtain a left boundary value of the scaled coordinate axis value range, and multiply a right boundary value of the original coordinate axis value range of the coordinate axis by a second coefficient to obtain a right boundary value of the scaled coordinate axis value range, where the first coefficient is greater than 1, and the second coefficient is less than 1.

The scaling-down subunit is configured to, when the scaling trigger operation is a scaling-down operation, multiply the left boundary value of the original coordinate axis value range of the coordinate axis by a third coefficient to obtain the left boundary value of the scaled coordinate axis value range, and multiply the right boundary value of the original coordinate axis value range of the coordinate axis by a fourth coefficient to obtain the right boundary value of the scaled coordinate axis value range, where the third coefficient is less than 1, and the fourth coefficient is greater than 1.

According to one or more embodiments of the present disclosure, Example 10 provides a display interaction apparatus, where the apparatus further includes a second generation unit and a second display unit.

The second generation unit is configured to perform lateral offset on the original coordinate axis value range of the coordinate axis to generate a second offset coordinate axis value range in response to a lateral moving trigger operation in the first area of the page or a second area of the page.

The second display unit is configured to re-display the coordinate axis according to the second offset coordinate axis value range.

According to one or more embodiments of the present disclosure, Example 11 provides a display interaction apparatus, where the coordinate axis is a time coordinate axis, and a coordinate axis value range of the time coordinate axis corresponds to a range of time, and the apparatus further includes a third display unit.

The third display unit is configured to re-display a displayed histogram corresponding to event statistical information with re-display of the coordinate axis, where each histogram corresponds to event statistical information of a same event type, the histogram includes at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an total amount event occurrence total number in the event statistical information.

According to one or more embodiments of the present disclosure, Example 12 provides a display interaction apparatus, where the coordinate axis is a time coordinate axis, and a coordinate axis value range of the time coordinate axis corresponds to a range of time, and the apparatus further includes a fourth display unit.

The fourth display unit is configured to re-display a displayed event time axis corresponding to event information with re-display of the coordinate axis, where the time coordinate axis is parallel to the event time axis, and the time coordinate axis corresponds to the time marked by the event time axis.

According to one or more embodiments of the present disclosure, Example 13 provides a display interaction apparatus, where an event node is displayed on the event time axis, and a display position of the event node corresponds to event occurrence time in the event information.

According to one or more embodiments of the present disclosure, Example 14 provides a display interaction apparatus, where the apparatus further includes a determination unit and a fifth display unit.

The determination unit is configured to perform longitudinal offset on a longitudinal display position of the event time axis to re-determine the longitudinal display position of the event time axis in response to a longitudinal moving trigger operation in a second area of the page.

The fifth display unit is configured to re-display the event time axis according to the longitudinal display position of the event time axis.

According to one or more embodiments of the present disclosure, Example 15 provides a display interaction device, which includes a memory, a processor, and a computer program that is stored on the memory and executable on the processor. The display interaction method according to any of Example 1 to Example 7 is implemented when the computer program is executed by the processor.

According to one or more embodiments of the present disclosure, Example 16 provides a computer-readable storage medium, where the computer-readable storage medium stores instructions, and when the instructions are executed on a terminal device, the terminal device is caused to execute the display interaction method according to any of Example 1 to Example 7.

It should be noted that the various embodiments in the present disclosure are described in a progressive manner, and each embodiment focuses on the differences from other embodiments, and the same or similar parts between the various embodiments may be referred to each other. For the systems or apparatuses disclosed in the embodiments, since they correspond to the methods disclosed in the embodiments, the description thereof is relatively simple, and reference may be made to the description of the methods for related parts.

It should be understood that in the present disclosure, “at least one” refers to one or more, and “a plurality” refers to two or more. “And/or” is used to describe an association relationship between associated objects, and represents that three relationships may exist, for example, “A and/or B” may represent: only A exists, only B exists, and both A and B exist at the same time. A and B may be singular or plural. The character “/” generally indicates that the associated objects before and after are in an “or” relationship. “At least one of the following” or similar expressions refer to any combination of these items, including any combination of a single item (one) or a plurality of items (ones). For example, at least one (one) of a, b or c may represent: a, b, c, “a and b”, “a and c”, “b and c”, or “a and b and c”, where a, b, c may be single or multiple.

It should also be noted that in the present disclosure, relational terms such as first and second are only used to distinguish one entity or operation from another entity or operation, and do not necessarily require or imply that there is any such actual relationship or order between these entities or operations. Moreover, the terms “include”, “contain” or any other variants thereof are intended to cover non-exclusive inclusion, so that the processes, methods, articles or devices including a series of elements not only include those elements, but also include other elements not explicitly listed, or also include elements inherent to such processes, methods, articles or devices. In the absence of more restrictions, the element defined by the statement “include one . . . ” does not exclude the existence of another same element in the process, method, article or device including the element.

The steps of the methods or algorithms described in connection with the embodiments disclosed herein may be implemented directly in hardware, a software module executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or any other form of storage medium well-known in the art.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments shown herein, but is to be accorded the widest scope consistent with the principles and novel features disclosed herein.

1. A display interaction method, comprising:
in response to a scaling trigger operation in a first area of a page, acquiring a first display position corresponding to the scaling trigger operation on a displayed coordinate axis, and converting the first display position into a target coordinate axis value;
expanding or reducing an original coordinate axis value range of the coordinate axis to obtain a scaled coordinate axis value range;
acquiring a second display position corresponding to the target coordinate axis value in the scaled coordinate axis value range;
calculating a position deviation between the first display position and the second display position;
performing lateral offset on the scaled coordinate axis value range according to the position deviation to generate a first offset coordinate axis value range; and
re-displaying the coordinate axis according to the first offset coordinate axis value range.

2. The method according to claim 1, wherein the expanding or reducing an original coordinate axis value range of the coordinate axis to obtain a scaled coordinate axis value range, comprises:
when the scaling trigger operation is a scaling-up operation, multiplying a left boundary value of the original coordinate axis value range of the coordinate axis by a first coefficient to obtain a left boundary value of the scaled coordinate axis value range, and multiplying a right boundary value of the original coordinate axis value range of the coordinate axis by a second coefficient to obtain a right boundary value of the scaled coordinate axis value range, wherein the first coefficient is greater than 1, and the second coefficient is less than 1; and
when the scaling trigger operation is a scaling-down operation, multiplying the left boundary value of the original coordinate axis value range of the coordinate axis by a third coefficient to obtain the left boundary value of the scaled coordinate axis value range, and multiplying the right boundary value of the original coordinate axis value range of the coordinate axis by a fourth coefficient to obtain the right boundary value of the scaled coordinate axis value range, wherein the third coefficient is less than 1, and the fourth coefficient is greater than 1.

3. The method according to claim 1, further comprising:
performing lateral offset on the original coordinate axis value range of the coordinate axis to generate a second offset coordinate axis value range in response to a lateral moving trigger operation in the first area of the page or a second area of the page; and
re-displaying the coordinate axis according to the second offset coordinate axis value range.

4. The method according to claim 1, wherein the coordinate axis is a time coordinate axis, and a coordinate axis value range of the time coordinate axis corresponds to a range of time, and the method further comprises:
re-displaying a displayed histogram corresponding to event statistical information with re-display of the coordinate axis, wherein each histogram corresponds to event statistical information of a same event type, the histogram comprises at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an event occurrence total number in the event statistical information.

5. The method according to claim 1, wherein the coordinate axis is a time coordinate axis, and a coordinate axis value range of the time coordinate axis corresponds to a range of time, and the method further comprises:
re-displaying a displayed event time axis corresponding to event information with re-display of the coordinate axis, wherein the time coordinate axis is parallel to the event time axis, and the time coordinate axis corresponds to time marked by the event time axis.

6. The method according to claim 5, wherein an event node is displayed on the event time axis, and a display position of the event node corresponds to event occurrence time in the event information.

7. The method according to claim 5, further comprising:
performing longitudinal offset on a longitudinal display position of the event time axis to re-determine the longitudinal display position of the event time axis in response to a longitudinal moving trigger operation in a second area of the page; and
re-displaying the event time axis according to the longitudinal display position of the event time axis.

8. (canceled)

9. A display interaction device, comprising at least one memory, at least one processor, and a computer program that is stored on the at least one memory and executable on the at least one processor, wherein when executing the computer program, the at least one processor implements a display interaction method, and the method comprises:
in response to a scaling trigger operation in a first area of a page, acquiring a first display position corresponding to the scaling trigger operation on a displayed coordinate axis, and converting the first display position into a target coordinate axis value;
expanding or reducing an original coordinate axis value range of the coordinate axis to obtain a scaled coordinate axis value range;
acquiring a second display position corresponding to the target coordinate axis value in the scaled coordinate axis value range;
calculating a position deviation between the first display position and the second display position;
performing lateral offset on the scaled coordinate axis value range according to the position deviation to generate a first offset coordinate axis value range; and
re-displaying the coordinate axis according to the first offset coordinate axis value range.

10. A non-transitory computer-readable storage medium, wherein the non-transitory computer-readable storage medium stores instructions, and when the instructions are executed on a terminal device, the terminal device is caused to execute a display interaction method, and the method comprises:
in response to a scaling trigger operation in a first area of a page, acquiring a first display position corresponding to the scaling trigger operation on a displayed coordinate axis, and converting the first display position into a target coordinate axis value;
expanding or reducing an original coordinate axis value range of the coordinate axis to obtain a scaled coordinate axis value range;
acquiring a second display position corresponding to the target coordinate axis value in the scaled coordinate axis value range;
calculating a position deviation between the first display position and the second display position;
performing lateral offset on the scaled coordinate axis value range according to the position deviation to generate a first offset coordinate axis value range; and
re-displaying the coordinate axis according to the first offset coordinate axis value range.

11. The method according to claim 6, further comprising:
performing longitudinal offset on a longitudinal display position of the event time axis to re-determine the longitudinal display position of the event time axis in response to a longitudinal moving trigger operation in a second area of the page; and
re-displaying the event time axis according to the longitudinal display position of the event time axis.

12. The display interaction device according to claim 9, wherein the expanding or reducing an original coordinate axis value range of the coordinate axis to obtain a scaled coordinate axis value range, comprises:
when the scaling trigger operation is a scaling-up operation, multiplying a left boundary value of the original coordinate axis value range of the coordinate axis by a first coefficient to obtain a left boundary value of the scaled coordinate axis value range, and multiplying a right boundary value of the original coordinate axis value range of the coordinate axis by a second coefficient to obtain a right boundary value of the scaled coordinate axis value range, wherein the first coefficient is greater than 1, and the second coefficient is less than 1; and
when the scaling trigger operation is a scaling-down operation, multiplying the left boundary value of the original coordinate axis value range of the coordinate axis by a third coefficient to obtain the left boundary value of the scaled coordinate axis value range, and multiplying the right boundary value of the original coordinate axis value range of the coordinate axis by a fourth coefficient to obtain the right boundary value of the scaled coordinate axis value range, wherein the third coefficient is less than 1, and the fourth coefficient is greater than 1.

13. The display interaction device according to claim 9, wherein the method further comprises:
performing lateral offset on the original coordinate axis value range of the coordinate axis to generate a second offset coordinate axis value range in response to a lateral moving trigger operation in the first area of the page or a second area of the page; and
re-displaying the coordinate axis according to the second offset coordinate axis value range.

14. The display interaction device according to claim 9, wherein the coordinate axis is a time coordinate axis, and a coordinate axis value range of the time coordinate axis corresponds to a range of time, and the method further comprises:
re-displaying a displayed histogram corresponding to event statistical information with re-display of the coordinate axis, wherein each histogram corresponds to event statistical information of a same event type, the histogram comprises at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an event occurrence total number in the event statistical information.

15. The display interaction device according to claim 9, wherein the coordinate axis is a time coordinate axis, and a coordinate axis value range of the time coordinate axis corresponds to a range of time, and the method further comprises:
re-displaying a displayed event time axis corresponding to event information with re-display of the coordinate axis, wherein the time coordinate axis is parallel to the event time axis, and the time coordinate axis corresponds to time marked by the event time axis.

16. The display interaction device according to claim 15, wherein an event node is displayed on the event time axis, and a display position of the event node corresponds to event occurrence time in the event information.

17. The display interaction device according to claim 15, wherein the method further comprises:
performing longitudinal offset on a longitudinal display position of the event time axis to re-determine the longitudinal display position of the event time axis in response to a longitudinal moving trigger operation in a second area of the page; and
re-displaying the event time axis according to the longitudinal display position of the event time axis.

18. The non-transitory computer-readable storage medium according to claim 10, wherein the expanding or reducing an original coordinate axis value range of the coordinate axis to obtain a scaled coordinate axis value range, comprises:
when the scaling trigger operation is a scaling-up operation, multiplying a left boundary value of the original coordinate axis value range of the coordinate axis by a first coefficient to obtain a left boundary value of the scaled coordinate axis value range, and multiplying a right boundary value of the original coordinate axis value range of the coordinate axis by a second coefficient to obtain a right boundary value of the scaled coordinate axis value range, wherein the first coefficient is greater than 1, and the second coefficient is less than 1; and
when the scaling trigger operation is a scaling-down operation, multiplying the left boundary value of the original coordinate axis value range of the coordinate axis by a third coefficient to obtain the left boundary value of the scaled coordinate axis value range, and multiplying the right boundary value of the original coordinate axis value range of the coordinate axis by a fourth coefficient to obtain the right boundary value of the scaled coordinate axis value range, wherein the third coefficient is less than 1, and the fourth coefficient is greater than 1.

19. The non-transitory computer-readable storage medium according to claim 10, wherein the method further comprises:
performing lateral offset on the original coordinate axis value range of the coordinate axis to generate a second offset coordinate axis value range in response to a lateral moving trigger operation in the first area of the page or a second area of the page; and
re-displaying the coordinate axis according to the second offset coordinate axis value range.

20. The non-transitory computer-readable storage medium according to claim 10, wherein the coordinate axis is a time coordinate axis, and a coordinate axis value range of the time coordinate axis corresponds to a range of time, and the method further comprises:
re-displaying a displayed histogram corresponding to event statistical information with re-display of the coordinate axis, wherein each histogram corresponds to event statistical information of a same event type, the histogram comprises at least one column structure, a start point of the column structure corresponds to start time in the event statistical information and is aligned with corresponding time in the time coordinate axis, an end point of the column structure corresponds to end time in the event statistical information and is aligned with corresponding time in the time coordinate axis, and a height of the column structure corresponds to an event occurrence total number in the event statistical information.

21. The non-transitory computer-readable storage medium according to claim 10, wherein the coordinate axis is a time coordinate axis, and a coordinate axis value range of the time coordinate axis corresponds to a range of time, and the method further comprises:
re-displaying a displayed event time axis corresponding to event information with re-display of the coordinate axis, wherein the time coordinate axis is parallel to the event time axis, and the time coordinate axis corresponds to time marked by the event time axis.
